(19) United States
(12) Patent Application Publication
(10) Pub. No.: US 2007/0171198 A1
(43) Pub. Date: Jul. 26, 2007

(54) Image display apparatus, image recording apparatus, and control system for image distribution

(75) Inventor: Toru Yokozawa, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/655,239

(22) Filed: Jan. 19, 2007

(30) Foreign Application Priority Data
Jan. 20, 2006 (JP) 2006-011839

(51) Int. Cl. G09G 5/00

(52) U.S. Cl. 345/156

(57) ABSTRACT

Because there is a limit in the number of functions included in a device (a television set or a recorder, etc), which are shared by a plurality of users over a network, the sharing is also limited. The conflict of sharing the device (or the function thereof) between the users requires one or more users to give up the use of the device. The device determines a user to which the priority is given and explicitly notifies the users how to resolve the conflict, based on a priority order which is assigned to each of the users beforehand.

### CLAIM OF PRIORITY

The present application claims priority from Japanese patent application No. JP2006-011839 filed on Jan. 20, 2006, the content of which is hereby incorporated by reference into this application.

### BACKGROUND OF THE INVENTION

The present invention relates to a technique for sharing, among a plurality of users, an apparatus which distributes video in a system in which video is mainly distributed through a network.

In recent years, a large amount of broadcast video is accumulated in a hard disk recorder or a DVD recorder, and the accumulated video is then redistributed through a home network. As a result, it is becoming possible to view recorded video by remote control even from a room that is apart from the recorder.

In order to embody such concepts, the standardization of interconnection between devices is being progressed by DLNA (Digital Living Network Alliance) so that video content, which is accumulated in a video device or a personal computer, is shared through a home network (DLNA Home Networked Device Interoperability Guidelines v1.0).

The DLNA is arguing not only video which has been recorded through a home network, but also an association with live broadcast video and a mobile terminal.

In a basic configuration of the DLNA, recorded video (for example, digital content that is compressed into an MPEG-2 format) and a list thereof are stored in a server (as described above, for example, the server is located in a living room, and a client is located in a room). First of all, the server is searched from the client located in the room that is apart from the server. Next, the list is acquired, and then the acquired list is output to a display screen of the client so as to allow a user to select video. After the completion of the selection, the specified video is transmitted as a stream from the server side to the client through the home network. Then, the client decodes the received data to provide the user with the decoded data as video.

In addition, when a live broadcast is redistributed from the server to the client, a channel is selected from the client by the same steps as above. Then, the server extracts a broadcast corresponding to the channel by use of a broadcast receiving unit, and transmits the broadcast to the home network. Next, the client decodes the video that has been received through the home network, and then provides the user with this as video.

Thus, because the interconnection can be achieved, it is becoming possible to share video. However, video transmission resources on the server side that is, a hard disk drive, a DVD drive, and a broadcast receiving unit, each of which includes accumulated video data, are resources, the number of which is limited. For example, sharing one broadcast receiving unit included in the server among four family members is not realistic. Therefore, for example, a broadcast receiving unit of another device, which is not being used on the network, is automatically searched to use the broadcast receiving unit. Such an idea is under examination (refer to Japanese Patent Application Laid-Open No. 2000-285598 and Japanese Patent Application Laid-Open No. 2005-252502).

### SUMMARY OF THE INVENTION

As a problem to be solved, because there is a limit in the number of functions included in a television set and a recorder, which are shared by a plurality of users over a network, it is natural that the sharing is also limited. In recent years, differently from the time when users can exclusively utilize a device because the device is used stand-alone, the network association is coming into widespread use. As a result, for example, a user who is using a function is requested by another user to release the function; or the user is forced to release the function. In another case, as a result of the remote control over a network, which is background processing, a state has changed from that expected by the user before the user noticed it. Therefore, an object of the present invention is to make the network association, which is difficult to understand for users, explicit and easy to understand, and thereby to improve the usability of an association function.

In order to achieve the above-described object, according to one aspect of the present invention, there is provided an image display apparatus comprising: at least one or more broadcast receiving units, each of which receives a broadcast and outputs a video signal; an user interface unit which performs selection operation by which a first user specifies one of the broadcast receiving units for viewing, and station selection operation of specifying a broadcast channel to be received by the selected broadcast receiving function; a display unit which presents, to the first user, a video signal that is output by the broadcast receiving unit selected through the user interface; and a network interface unit which connects an external device to one of the one or more broadcast receiving units, the external device being used by a second user to remotely perform each operation and viewing that are similar to those performed by the first user. In addition, the image display apparatus further comprises: a control unit which controls the selection of the broadcast receiving unit and the station selection on the basis of the priority order, which is given to each of the users beforehand, so as to resolve the conflict occurring when the first and second users share the broadcast receiving unit; and a station selection control unit which is capable of, when the control is performed on the basis of the priority order, transmitting, to each of the users, through the display unit, a message notifying that the conflict is resolved on the basis of the priority order.

According to another aspect of the present invention, there is provided an image recording apparatus comprising: at least one or more broadcast receiving units, each of which receives a broadcast and outputs a video signal; an user interface unit which performs selection operation by which a first user specifies one of the broadcast receiving units for viewing, and station selection operation of specifying a broadcast channel to be received by the selected broadcast receiving unit; a display unit which presents, to the first user, a video signal that is output by the broadcast receiving unit selected through the user interface; a programmed recording unit which records the video signal of the broadcast receiving unit from the time that is specified beforehand by the first user; and a network interface unit which connects an external device that is used by a second user to remotely perform each operation and viewing that are similar to those performed by the first user. The image recording apparatus further comprises: an assignment unit which when each user programs the recording by use of the programmed recording unit, assigns the same priority order also to the programmed recording on the basis of the priority order assigned to each user beforehand so that if the conflict of sharing the broadcast receiving unit occurs between the first user who uses the broadcast receiving unit for the programmed recording that is programmed by use of the programmed recording unit, and the second user who is using the broadcast receiving unit for viewing, the conflict can be resolved; and a station selection control unit. The station selection control unit includes: a control unit which controls the selection of the broadcast receiving unit and the station selection on the basis of the priority order assigned to each of the user and the priority order assigned to the programmed recording; and a presentation unit which, when the control is performed, presents to each of the users, through the display unit, a message notifying that the conflict will be resolved on the basis of said each priority order.

In a situation in which a plurality of users conflict with one another over networks, the users are provided beforehand with the priority order of using a function to be used, and a message relating to the conflict resolution is displayed. Accordingly, viewing is not suddenly interrupted, and the users understand the interruption as processing according to the priority order. Therefore, it is possible to make sharing of an AV device over networks explicit and easy to understand, which is an advantage.

### BRIEF DESCRIPTION OF THE DRAWINGS

FIG. 1 is a diagram schematically illustrating a configuration of a television set according to a first embodiment of the present invention;

FIG. 2 is a diagram schematically illustrating network connections according to the first embodiment of the present invention;

FIG. 3 is a diagram schematically illustrating a configuration of a monitor according to the first embodiment of the present invention;

FIG. 4 is a block diagram illustrating in detail a station selection controller according to the first embodiment of the present invention;

FIG. 5 is a diagram illustrating an example of a message that is displayed on the monitor according to the first embodiment of the present invention;

FIG. 6 is a diagram illustrating an example of a message that is displayed on the television set according to the first embodiment of the present invention;

FIG. 7 is a flowchart illustrating the process flow according to the first embodiment of the present invention;

FIG. 8 is a diagram illustrating an example of the content of the priority order registration according to the first embodiment of the present invention;

FIG. 9 is a diagram illustrating another example of the content of the priority order registration according to the first embodiment of the present invention;

FIG. 10 is a diagram illustrating an example of priority information that is displayed on the monitor according to the first embodiment of the present invention;

FIG. 11 is a diagram illustrating as an example how to check the priority according to the first embodiment of the present invention;

FIG. 12 is a diagram schematically illustrating a configuration of a recorder according to a second embodiment of the present invention;

FIG. 13 is a diagram illustrating an example of programmed recording information according to the second embodiment of the present invention; and

FIG. 14 is a chart supplementary illustrating a third embodiment of the present invention.

### DESCRIPTION OF THE PREFERRED EMBODIMENTS

In the conflict of using a function among users, in particular, for the purpose of reducing the difficulty in understanding of the association over networks, an improvement in convenience of users is achieved, with the flexibility of an association function being kept unchanged, by a technique for predetermining the priority order at the time of the occurrence of the conflict.

Embodiments of the present invention will be described in detail with reference to drawings as below.

### First Embodiment

A first embodiment of the present invention will be described as below.

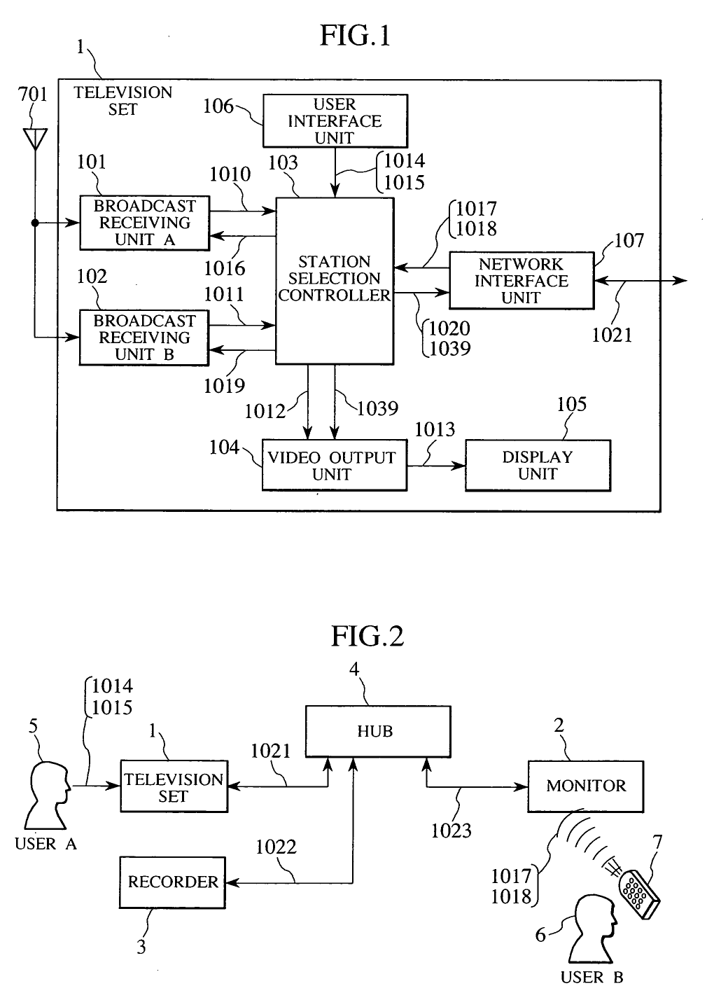

FIG. 1 is a diagram illustrating a configuration of a television set according to the first embodiment of the present invention.

This embodiment is based on the assumptions that there is a television set 1 including two broadcast receiving units, and that two users to which the use authority is given (a user A 5 who directly operates the television set 1 to view a program thereof, and a user B 6 who views the program through a home network) share the television set 1, and that for this use authority, the priority of the user A 5 is higher than that of the user B 6. Here, this embodiment assumes a scenario in which: firstly, the user A 5 uses one of the two broadcast receiving units and the user B 6 uses the other of them; next, the user A 5 requests the use of the broadcast receiving unit that is currently being used by the user B 6 so that the user A 5 can view another program; consequently, the conflict of using the broadcast receiving unit in question occurs between the users A 5 and B 6; and therefore the use authority is transferred to the user A 5 as a result of comparing the priority order between the users A 5 and B 6 as described above.

Incidentally, this scenario is based on the assumptions that the user A 5 has been identified as a user of the television set 1, whereas the user B 6 has been identified as a user of a monitor 2, as a result of performing user authentication, or the like, and that the undermentioned selection signal of the broadcast receiving unit is provided with a parameter indicating which user has inputted this signal when this signal is inputted from the undermentioned user interface, or the like.

In FIG. 1, reference numeral 1 denotes the television set; and reference numeral 101 denotes a broadcast receiving unit A. According to an instruction of the undermentioned station selection signal A 1016, the broadcast receiving unit A outputs the video of a corresponding broadcast program (channel) as a video signal A 1010. In addition, reference numeral 102 denotes a broadcast receiving unit B having the same function as that of the broadcast receiving unit A 101. According to an instruction of the undermentioned station selection signal B 1019, the broadcast receiving unit B outputs the video of a corresponding broadcast program (channel) as a video signal B 1011.

Reference numeral 103 denotes a station selection controller. The station selection controller performs switching control including the steps of: receiving a receiving-unit selection signal A 1014 or a station-selection operation signal A 1015 from the undermentioned user interface unit 106; further receiving a receiving-unit selection signal B 1017 and a station-selection operation signal B 1018 from the undermentioned network interface unit 107, the receiving-unit selection signal B 1017 and the station-selection operation signal B 1018 coming from the monitor 2 that is connected through a home network A 1021; and on the basis of the priority order that is assigned to the user A 5 who is using each of the signals and the undermentioned television set 1, and to the user B 6 of the monitor 2, switching destinations of video signals, which are output by the broadcast receiving unit A 101 and the broadcast receiving unit B 102, so that a video signal to be supplied to the user A 5 is output as a station-selection video signal A 1012, whereas a video signal to be supplied to the user B 6 is output as a station-selection video signal B 1020 (although the station-selection video signal A 1012 and the station-selection video signal B 1020 are expressed with one line as a result of omitting the illustration thereof, there is also a case where both the video signal A 1010 and the video signal B 1011 which are output by the broadcast receiving units A 101 and B 102 are included at the same time, and therefore it is also possible for one user to use a plurality of broadcast receiving units).

Moreover, when the processing is performed on the basis of the priority order, the station selection controller 103 outputs, to the video output unit 104 and the network interface unit 107, priority information 1039 that is used to provide the user A 5 and the user B 6 with a proper message describing the result of the processing. Reference numeral 104 denotes a video output unit for combining the video signal received from the station selection controller 103 as the above-mentioned station-selection video signal A 1012 with the above-mentioned priority information 1039 to output the combined signal to the undermentioned display unit 105. Reference numeral 105 denotes a display unit for, on the receipt of a display video signal 1013 that is output from the video output unit 104, presenting the display video signal 1013 to the undermentioned user A 5. Reference numeral 106 denotes an user interface unit through which the user A 5 who is using the television set 1 inputs an operation instruction to use a function of the television set 1. The user interface is used to give an instruction to select a broadcast receiving unit, and to select a program (station) to be received by the broadcast receiving unit.

Reference numeral 107 denotes a network interface unit that is used to connect the above-mentioned monitor 2 and the undermentioned recorder 3 for recording video to the television set 1 through the undermentioned home network A 1021. The station-selection video signal B 1020 is output to the home network A 1021 through this network interface unit. Further, the network interface unit 107 receives commands (the receiving-unit selection signal B 1017 and the station-selection operation signal B 1018 described below). These commands are transmitted by the user B 6 who is using the monitor 2 for the remote control of the television set 1 through the monitor 2. The network interface unit 107 then inputs these commands to the station selection controller 103.

Reference numeral 1014 denotes a receiving-unit selection signal A that enables the user A 5 who is using the television set 1 to use both or either of the broadcast receiving units A 101, B 102 by use of a signal inputted from the user interface unit 106. Reference numeral 1015 denotes a station-selection operation signal A that is used to set a broadcast channel to be selected by a broadcast receiving unit (both or either of A101 and B102) specified by the receiving-unit selection signal A 1014.

Next, reference numerals 1016 and 1019 are station selection signals A and B. Here, the station selection signals A and B correspond to the station-selection operation signal A 1015 and the undermentioned station-selection operation signal B 1018 that are transmitted to the broadcast receiving unit A 101 and the broadcast receiving unit B 102 respectively by the station selection controller 103 on the basis of the result of judging the priority order. Reference numeral 1017 denotes a receiving-unit selection signal B that enables the user B 6 to use both or either of the broadcast receiving unit A 101 and B 102. The receiving-unit selection signal B is transmitted through the home network A 1021 as a result of the operation of the monitor 2 by the user B 6 who is using the monitor 2. Reference numeral 1018 denotes a station-selection operation signal B that is used to set a broadcast channel to be selected by a broadcast receiving unit (both or either of A 101 and B 102) whose use is allowed by the receiving-unit selection signal B 1017. Reference numeral 1039 is priority information that is used to indicate the priority order of each user.

Reference numeral 701 denotes an antenna for inputting airwaves into the broadcast receiving units A and B. Incidentally, as described above, it is possible to transmit either the video signal A 1010 or the video signal B 1011 through the station-selection video signal A 1012 and the station-selection video signal B 1020. However, although not illustrated, it is also possible to transmit both of the signals at the same time through the station-selection video signal A 1012 and the station-selection video signal B 1020.

FIG. 2 is a diagram illustrating a network configuration according to a first embodiment of the present invention. Reference numeral 1 denotes a television set. Reference numeral 2 denotes a monitor that is connected through the home networks A 1021 and a home network C 1023. The user B 6 uses the monitor to remotely view the video received by the television set 1. Reference numeral 3 denotes a recorder that is a third device in this embodiment. The recorder is connected to the home network B 1022. Reference numeral 4 denotes a HUB for connecting among the television set 1, the monitor 2, and the recorder 3 through the home networks. Reference numeral 5 denotes a user A who is using the television set 1; reference numeral 6 denotes a user B who is using the monitor; and reference numeral 7 denotes a remote control unit with which the user B 6 operates the monitor 2.

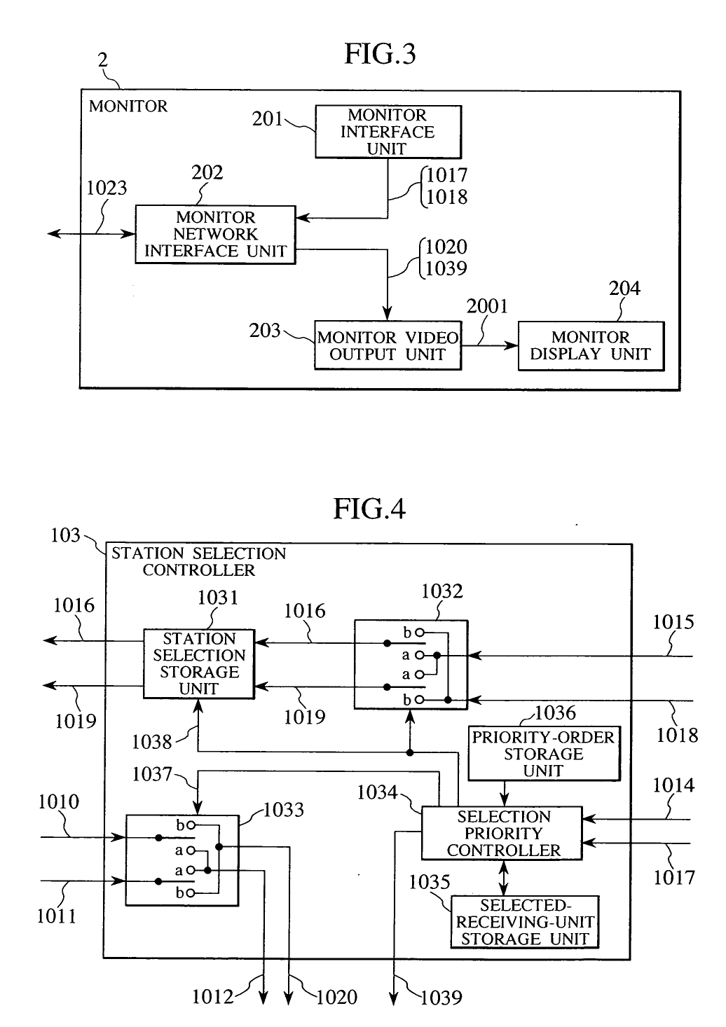

FIG. 3 is a diagram illustrating a configuration of the monitor 2 according to the first embodiment of the present invention. Reference numeral 201 denotes a monitor interface unit for outputting input signals (the receiving-unit selection signal B1017 and the station-selection operation signal B1018) to the undermentioned monitor network interface unit. These input signals are inputted from the remote control unit 7. Reference numeral 202 denotes a monitor network interface unit for connecting the monitor 2 to the home network C 1023, for outputting the receiving-unit selection signal B 1017 and the station-selection operation signal B 1018, which are inputted from the monitor interface unit 201, to the television set 1 so as to associate with the television set 1, and for receiving the station-selection video signal B 1020 and the priority information 1039 from the television set 1 to input them into the undermentioned monitor video output unit 203.

Reference numeral 203 denotes a monitor video output unit for combining the station-selection video signal B 1020 and the priority information 1039, which are inputted from the monitor network interface unit 202, into video to create the display video signal 2001, and then for displaying the display video signal 2001 on a monitor display unit 204. Reference numeral 204 denotes a monitor display unit for receiving the video signal from the monitor video output unit to display the video signal.

FIG. 4 is a diagram illustrating a configuration of the station selection controller 103 according to the first embodiment of the present invention. Reference numeral 1031 denotes a station-selection storage unit for, when the station selection signal A 1016 and the station selection signal B 1019 are output to the broadcast receiving unit A 101 and the broadcast receiving unit B 102 on the basis of the result of judging the priority order, storing the latest judgment result on a user basis (the role of storing will be described below).

Reference numeral 1032 denotes a station selection signal controller for performing the assignment control so that the each of station-selection operation signal A 1015 and the station-selection operation signal B 1018, which are inputted by the users A 5 and B 6 to select a desired broadcast program (channel), is properly assigned to the station selection signal A 1016 or the station selection signal B 1019 on the basis of the priority order given to each user. The assignment can be controlled by switching a switch included in the station selection signal controller 1032 (in the case of this embodiment, a two-contact-point switch having contact points a and b is provided so that the two station-selection operation signals A and B can be arbitrarily assigned to the two station selection signals A and B) in response to a state of a station selection signal 1038 that is output by the undermentioned selection priority controller 1034 on the basis of the judgment result of the priority order. For example, the station-selection operation signal A 1015 is assigned as a station selection signal A 1016, and the station-selection operation signal A 1015 is assigned to both the selection signals A 1016 and B 1019 (the selection signal B 1018 is also assigned in a similar manner).

Reference numeral 1033 denotes a broadcast receiving unit selection controller for performing assignment control so that each of the video signal A 1010 and the video signal B 1011 described above is assigned to the selection video signal A 1012 or the selection video signal B 1020. On the basis of the result of judging which priority is higher between the priority given to the user A 5 and that given to the user B 6, the assignment control is performed by switching a switch included in the broadcast receiving unit selection controller 1033 (in the case of this embodiment, a two-contact-point switch having contact points a and b, which is capable of arbitrarily assigning the video signals A 1010 and B 1011 to two station selection video signals A and B) in response to a state of a video selection signal 1037 output from the undermentioned selection priority controller 1034. For example, the video signal A 1010 can be assigned to the station-selection video signal A 1012; or the video signal B 1011 can be assigned to the station-selection video signal B 1020. Furthermore, both the video signal A 1010 and the video signal B 1011 can also be assigned to the station-selection video signal A 1012.

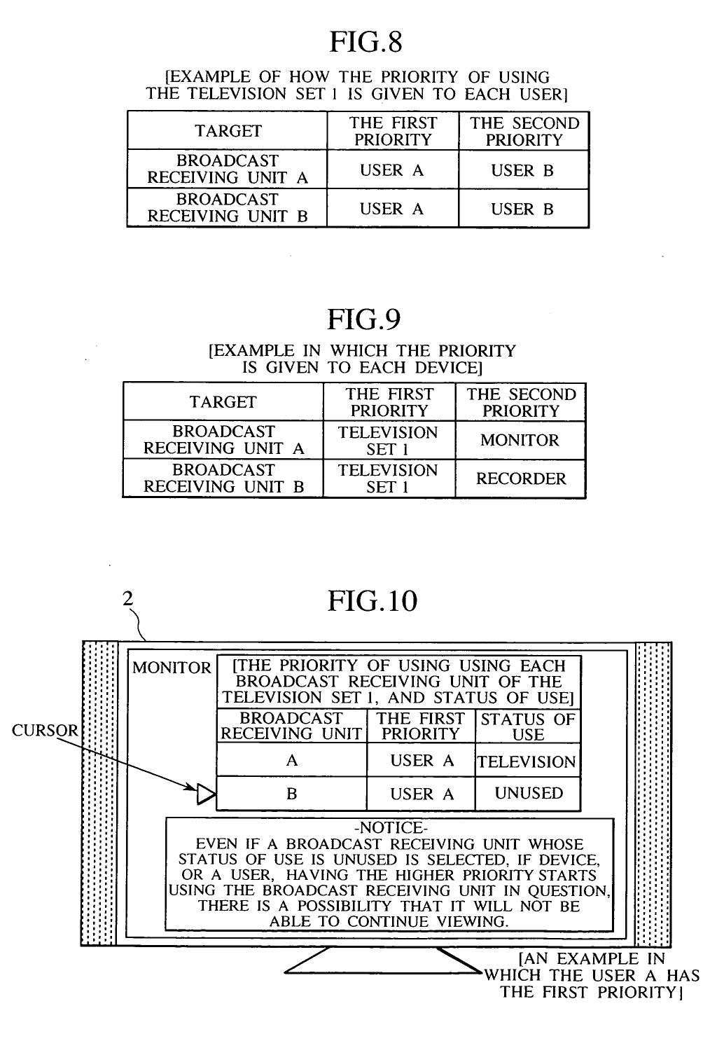

Reference numeral 1034 denotes a selection priority controller. Here, the selection priority controller generates the video selection signal 1037 and the station selection signal 1038 on the basis of the receiving-unit selection signal A 1014 inputted by the user A 5 and the receiving-unit selection signal B 1017 inputted by the user B 6, and on the basis of the order read out from a priority-order storage unit 1036 that stores beforehand the priority order of each user (incidentally, as described above, information indicating a user who has inputted each signal is added to the receiving-unit selection signal A 1014 and the receiving-unit selection signal B 1017, and on the basis of the information, for example, the priority order at this point of time is read out from a priority order table as shown in FIG. 8 so as to make a comparison).

As a state of each signal, for example, on the assumption that the user A 5 selects the use of the broadcast receiving unit A 101 by the receiving-unit selection signal A 1014, whereas the user B 6 selects the use of the broadcast receiving unit B 102 by the receiving-unit selection signal B 1017, this selection pattern does not cause a conflict between them. Accordingly, it is not necessary to refer to the priority order here. Therefore, as requested by each user, the video selection signal 1037 switches the video signal A 1010 to the “a side” (to provide the user A with a video signal as the station-selection video signal A 1012), and switches the video signal B 1011 to the “b side” (to provide the user B with a video signal as the station-selection video signal B 1020). In addition, the station selection signal 1038 is also so controlled that the station selection signal A 1016 is switched to the “a side” (to assign the station-selection operation signal A 1015), whereas the station selection signal B 1019 is switched to the “b side” (to assign the station-selection operation signal B 1018). As a result, the user A 5 can view the desired broadcast program using the broadcast receiving unit A 101 by the station-selection operation signal A 1015. On the other hand, the user B 6 can view the desired broadcast program using the broadcast receiving unit B 102 by the station-selection operation signal B 1018.

Moreover, as another example, if the user A 5 selects the broadcast receiving unit B 102 by the receiving-unit selection signal A 1014 after the above-described state, the use of the broadcast receiving unit B 102 conflicts with the user B. Then, the selection priority controller 1034 refers to the priority-order storage unit 1036 here, and thereby judges that the user A 5 has the higher priority (this embodiment is based on the assumption that the priority of the user A 5 who is using the television set 1 is higher than that of the user B 6 who is using the television set 1 through the network). Therefore, the control is performed so that a state of the video selection signal 1037 causes switches, which are connected to the video signal A 1010 and the video signal B 1011, to be switched to the “a side”, and that a state of the station selection signal 1038 also causes switches, which are connected to the station selection signal A 1016 and the station selection signal B 1019, to be switched to the “a side”. As a result, the user A 5 uses both of the broadcast receiving units A 101 and B 102, and accordingly both of the video signals are supplied to the display unit 105 of the television set 1 as the station-selection video signal A 1012 (for example, it can be thought that the display unit displays two broadcast screens at a time with two broadcast video images being displayed on a reduced scale).

In addition, the selection priority controller 1034 has a function of outputting the priority information 1039 that is used to explicitly present a state of the set priority to a user by use of a message, or the like. By transmitting this information to the display unit 105 through the video output unit 104, or by transmitting this information to the monitor 2 through the network interface unit 107, it is possible to present the state of the set priority order of the users A5 and B6 to the broadcast receiving units A101 and B102 (for example, shown in FIG. 8).

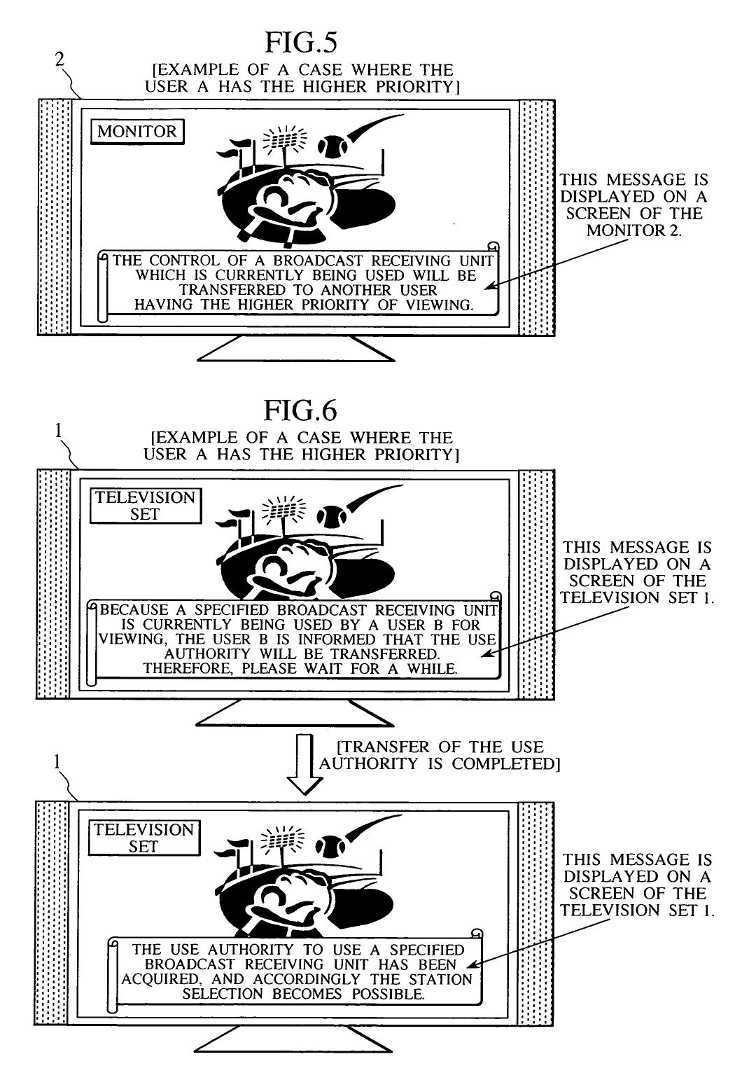

In addition, the selection priority controller 1034 has a function of, as a result of judging the priority order on the basis of the priority-order storage unit 1036, if a transfer of the use authority occurs, displaying a message as shown in FIG. 5 by use of the priority information 1039 for a user on the side of releasing the use authority to inform beforehand that a transfer of the authority occurs (for example, it is thought that a transfer is executed 10 seconds after the display).

Moreover, the selection priority controller 1034 also has a function of: presenting the message shown FIG. 5 to a user on the side of releasing the use authority; and at the same time, until the authority is completely acquired as shown in an example in FIG. 6, informing, as the priority information 1039, a user who is provided with the authority that the other user is being notified of the transfer of the authority; and then informing the user who is provided with the authority that the authority has been completely acquired; and thereby making the user know the situation of processing relating to the transfer of the authority.

Reference numeral 1035 denotes a selected-receiving-unit storage unit for storing information about a user who is currently using each broadcast receiving unit (in this case, the user B 6 or the user A 5). Using the selected receiving unit storage unit, even in a state in which the receiving-unit selection signal A 1014 or B 1017 is not inputted from the user when the television set is turned on again after it has been temporarily turned off, the latest state immediately before the television set which is stored in this selected-receiving-unit storage unit 1035 has been turned off is read out so that the first video selection signal 1037 and the first station selection signal 1038 are output.

Reference numeral 1036 denotes a priority-order storage unit. FIG. 8 illustrates an example of the priority-order storage unit. In this embodiment, as shown in FIG. 8, which specifies the priority order of the users to use the broadcast receiving units A 101 and B 102 of the television set 1, the priority of the user A 5 is higher than that of the user B 6 for both of the broadcast receiving units A 101 and B 102. In addition, FIG. 9 also illustrates an example. In this example, the priority given to operation of each device is shown (to be more specific, regardless of a user who uses a device, in order to determine the priority of viewing, the priority order which is assigned beforehand to each device to be used is referred to). To be more specific, it is shown that the first operation priority of each of the broadcast receiving units included in the television set 1 is given to the operation from the television set 1, and that the second operation priority of the broadcast receiving unit A 101 is given to the monitor 2, whereas the second operation priority of the broadcast receiving unit B 102 is given to the recorder 3.

Besides them, although not illustrated, it is also possible to use the following priority settings: setting the priority on the basis of a network through which a terminal is connected (for example, the first priority is given to a device having a specific IP address, and the second priority is given to a device whose IP address is within a certain range; and even in the case of the same device, changing the priority order depending on a time zone (for example, the higher priority is given to the operation from a monitor in a children's room during the children's program time, whereas the higher priority is given to a television set in a living room at night). Moreover, it is also possible to register the priority order into which the above time zone conditions and conditions based on a device, a person, a network ID, and the like are combined. As a matter of course, a message for properly explaining the use authority to users is prepared in response to each of the priority settings.

Embodiments of the present invention will be described with reference to FIGS. 1 through 10 as below.

As shown in FIG. 2, there is a home in which the television set 1, the monitor 2, and the recorder 3 are connected to one another through the HUB 4 and the home networks A, B, C. Here, the user A 5 and the user B 6 try to use the broadcast receiving unit A 101 and the broadcast receiving unit B 102 respectively, both of which are included in the television set 1.

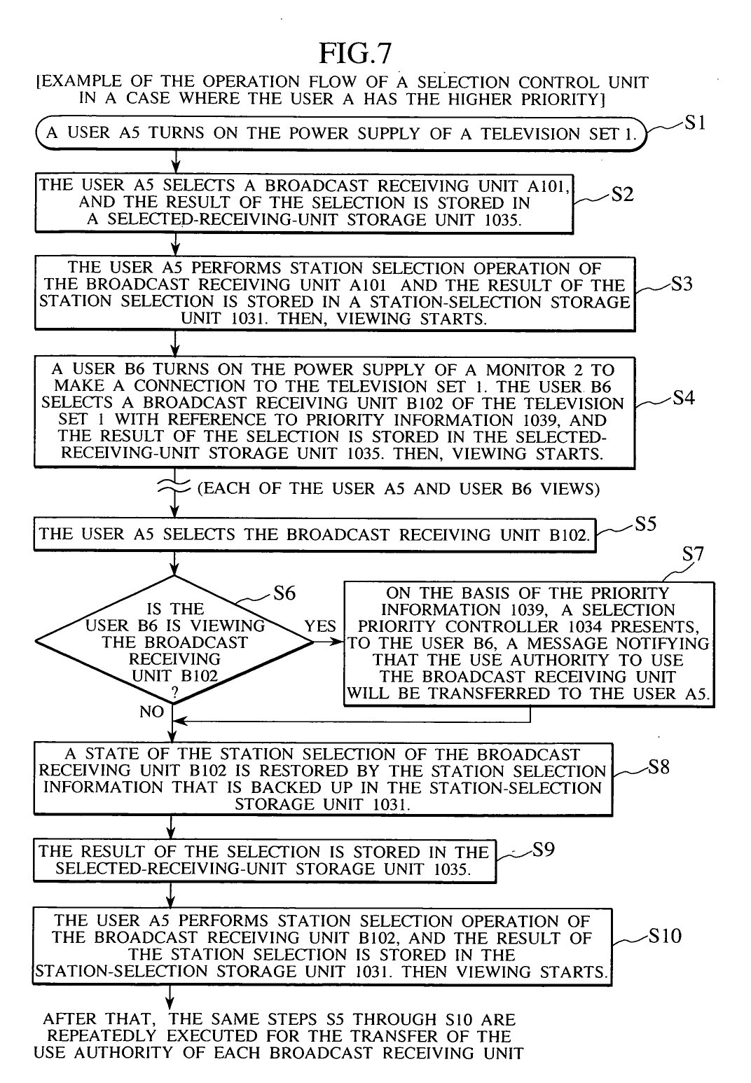

This state will be described with reference to a flowchart shown in FIG. 7. It is to be noted that S1 through S11 shown in FIG. 7 are steps of the flow.

First of all, the user A 5 turns on the power supply of the television set 1 (S1). Next, the user A 5 instructs the use of the broadcast receiving unit A 101 through the user interface unit 106. As a result, the receiving-unit selection signal A 1014 is inputted into the selection priority controller 1034. Then, the selection priority controller 1034 refers to the priority-order storage unit 1036 to check the priority order of the user A 5.

As shown in FIG. 8 as an example, because the priority order of the user A 5 is the first, the user A 5 can use the broadcast receiving unit A 101 in preference to the other users. The broadcast receiving unit selection controller 1033 performs control so that in response to the video selection signal 1037, the video signal A 1010 passes through the “a side” of the switch. In addition to it, the station selection signal controller 1032 performs control so that in response to the station selection signal 1038, the station-selection operation signal A 1015 passes through the “a side” of the switch, and then reaches the broadcast receiving unit A 101 as the station selection signal A 1016. Moreover, at the same time, information showing that the user A 5 is currently using the broadcast receiving unit A 101 is stored in the selected-receiving-unit storage unit 1035 (S2).

The user A 5 can select a favorite program by transmitting the station-selection operation signal A 1015 to the broadcast receiving unit 101. In addition, the station selection operation at this point of time is stored in the station-selection storage unit 1031 as latest information (S3).

Next, if the user B 6 requests the use of the television set 1 from the monitor 2 through the home networks C 1023 and A 1021 by use of the receiving-unit selection signal B 1017, the selection priority controller 1034 makes a comparison with information stored in the priority-order storage unit 1036. As a result, it is judged that the user A 5 is not using the broadcast receiving unit B 102. Therefore, the monitor 2 displays a message as shown in FIG. 10 on the screen thereof (S4).

Judging from the displayed message, the user B 6 knows that although the first priority order of the broadcast receiving unit B 102 is assigned to the user A 5, the broadcast receiving unit B 102 can be used because it is not currently being used. Accordingly, the user B 6 instructs the use of the broadcast receiving unit B 102 by, for example, placing a cursor to the broadcast receiving unit B on the screen using the remote control unit 7. Then, the broadcast receiving unit selection controller 1033 performs control so that in response to the video selection signal 1037, the video signal B 1011 passes through the “b side” of the switch. In addition to it, the station selection signal controller 1032 performs control so that in response to the station selection signal 1038, the station-selection operation signal B 1018 passes through the “b side” of the switch. As a result, the station selection signal B 1019 is reflected by the request of the user B 6.

As described above, in a state in which no conflict occurs, both the user A 5 and the user B 6 can receive a requested broadcast to enjoy viewing of the broadcast.

Next, in the above-described state, if the user A 5 uses the receiving-unit selection signal A 1014 to instruct the use of the broadcast receiving unit B 102 that is currently being used by the user B 6 (S5), the selection priority controller 1034 first detects that the user B 6 is currently using the broadcast receiving unit B 102 (S6). Next, the selection priority controller 1034 makes a judgment of the priority order with reference to information stored in the priority-order storage unit 1036. As a result, before the transfer of the use authority, the selection priority controller 1034 uses the priority information 1039 to provide the user B 6 with a message notifying that the use authority of the broadcast receiving unit B 102 will be transferred to the user A 5 whose priority is higher (S7).

Subsequently, the last station selection signal stored in the station-selection storage unit 1031, by which the user A 5 has operated the broadcast receiving unit B 102 before, is automatically read out. The station selection signal in question is then output as the station selection signal B 1019 (S8) (as a result of this processing, it is not necessary for the user A 5 to feel the difference with a state of the station selection performed by the user A 5 in the past even if the station selection of the broadcast receiving unit B 102 has been changed by the other users; incidentally, the timing in which this operation is started may be the timing in which the priority is acquired as described above, or may also be the timing in which the broadcast receiving unit B 102 returns to an unused state as a result of the interruption of viewing by the user B 6).

Lastly, information indicating that the user A 5 has become a new user of the broadcast receiving unit B 102 is stored in the selected-receiving-unit storage unit 1035.

Thus, in this embodiment, in a state in which the conflict occurs, the use authority is transferred to a user whose priority is higher so as to resolve the conflict state. In addition, the occurrence of this processing is properly presented to each user by use of a message. As a result, even a user like the user B 6 cannot directly observe the transfer of the viewing authority to the user A 5 because the user in question is using a device over the network, it becomes possible to reduce a possibility that confusion will arise when a viewing state changes.

Incidentally, because the steps can be sufficiently guessed by the above-described flow, the description of the steps will be omitted. However, opposite to the above-described example, if the station selection operation performed by user B 6 having the lower priority conflicts with the broadcast receiving unit that is currently viewed by the user A 5 as the result (more specifically, if the broadcast receiving unit A 101 is selected in the above (S4)), the user A 5 having the higher priority is currently using the broadcast receiving unit A 101. Therefore, it may also be so configured that the selection priority controller 1034 uses the priority information 1039 to present, to a user whose priority is lower, a message notifying that it is not possible to get the use authority because the broadcast receiving unit A 101 in question is being used by the user 5A having the higher priority. This message clears the reason why the use authority cannot be acquired.

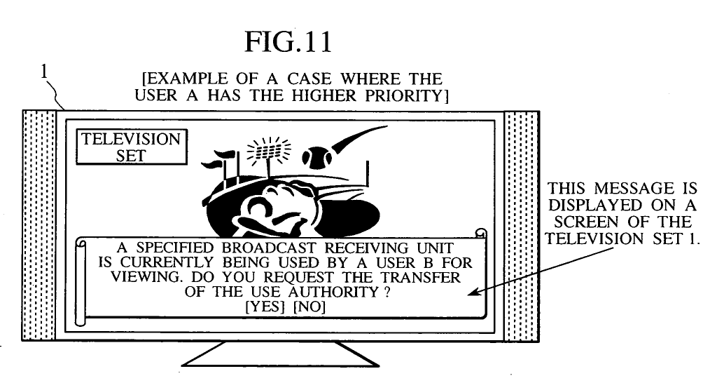

In addition, in the first message shown in FIG. 6, which is given to a user whose priority order is higher, it is also possible to provide the user A 5 with an opportunity to select “Yes” or “No” as shown in FIG. 11. In this case, after the user A 5 selects “Yes”, if a notification shown in FIG. 6 is transmitted to the other user, the other user can consciously confirm the notification, and accordingly how to handle the priority can be easily understood.

Moreover, in the above flowchart, the message is presented before the use authority is transferred (S7). However, in order to emphasize the transfer of the use authority, another message notifying that the use authority has been transferred may also be presented after the transfer of the use authority.

In addition, although not illustrated in detail, this embodiment is based on the assumption that the number of broadcast receiving units is two. However, if the number of broadcast receiving units is one, a function of controlling the broadcast receiving unit is not required. However, even in such a case, it is obvious that the same processing as above, which is based on the priority order, can be applied to the conflict resolution of the station selection.

Further, it may also be so configured that by providing the monitor 2 with a message storing function of storing a message relating to the transfer of the use authority, and by reading if necessary, from the monitor interface unit 201, a message that has been stored last by the message storing function, it becomes possible to check a user to which the use authority has been transferred, and the reason why the use authority has been transferred, at anytime.

Moreover, it may also be so configured that in a message notifying beforehand that the use authority will be transferred, there is presented a step for rejecting the transfer based on the priority order (for example, “Yes” or “No”), the transfer being performed by a user whose priority is higher (that is to say, a requester).

This embodiment is based on the assumption that if the use authority of a broadcast receiving unit is transferred, a user who has released the priority cannot view by use of the broadcast receiving unit. However, it may also be so configured that even if the user has no authority to perform the station selection operation (more specifically, switching of broadcast programs), the user can continuously view the same broadcast program as a program that is currently being viewed by a user having the priority.

In addition, in this case, it may also be so configured that if the user A 5 having the higher priority performs the station selection operation of switching to another broadcast program, a message notifying that the broadcast program which is currently being viewed is switched to another broadcast program by the user A 5 is presented by use of the priority information 1039, in synchronization with the switching, to the user B 6 having the lower priority who is viewing at the same time. Moreover, it may also be so configured that a message and guidance based on the priority information 1039 are displayed in the display unit 105 so that the user who has acquired the use authority can select between allowing/disallowing a user having the lower priority to view the same program, and then the selecting between allowing/disallowing is made by the operation from the user interface to enable the selection priority controller 1034 to perform shared viewing control.

In this embodiment, the broadcast receiving unit selection controller 1033 and the station selection signal controller 1032 are configured by hardware which uses switches so that the description thereof can be easily understood. However, as a matter of course, these controllers may also be implemented by software.

### Second Embodiment

A second embodiment of the present invention will be described as below.

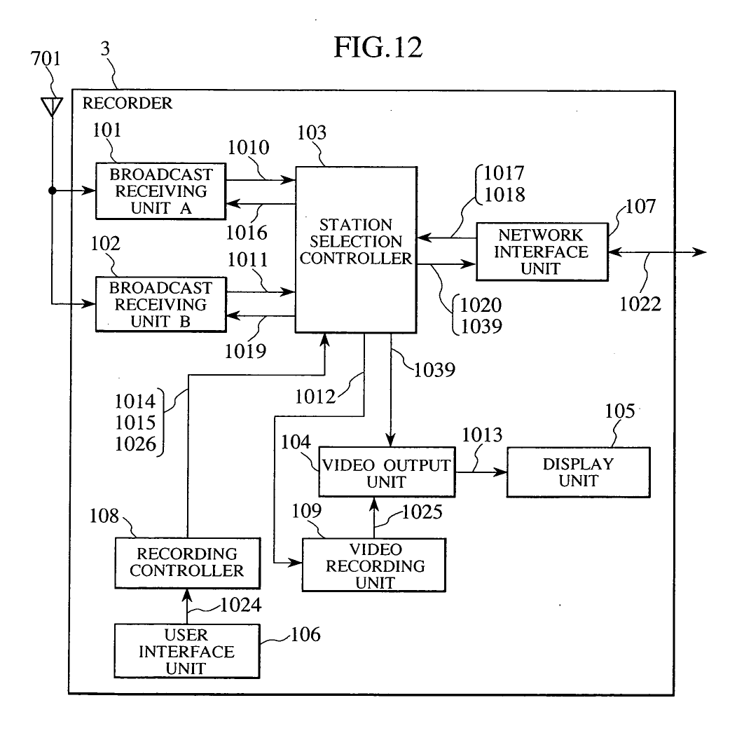

FIG. 12 is a diagram illustrating a configuration of a recorder according to the second embodiment of the present invention.

In this embodiment, as is the case with the television set 1, the recorder 3 includes two broadcast receiving units. As is the case with the first embodiment, the priority of the user A 5 who uses the recorder 3 is higher than that of the user B 6 who uses the recorder 3 through the home network B 1022.

In addition, the user A 5 has programmed the recorder 3 to record a program. Accordingly, when the programmed recording time comes, the broadcast receiving unit which is not being used at this point of time will be used for recording as a result of the execution of the programmed according to which the priority order of the user A 5 is assigned.

As described below, this embodiment has the following scenario: for example, in the above-described configuration, before the programmed recording starts, the user B 6 is viewing a broadcast program by use of one of the broadcast receiving units included in the recorder 3; in this situation, in order to start recording of the user A 5 having the higher priority, the recording being instructed to use the same broadcast receiving unit, the user B 6 is requested by the recorder 3 to release the use authority of the broadcast receiving unit in question.

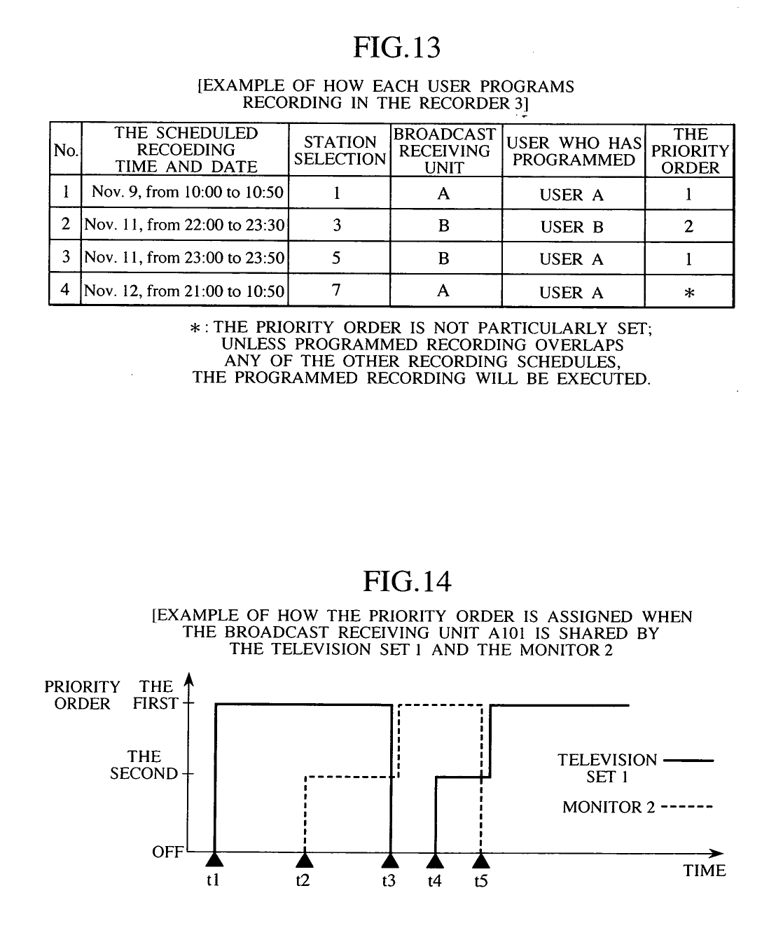

In FIG. 12, reference numeral 3 denotes the recorder, and reference numeral 108 denotes a recording controller. Here, the recording controller 108 stores programmed recording information 1024 (FIG. 13) received from a user through the user interface unit 106. When the specified time comes, the recording controller 108 reads out the programmed recording information 1024, and then inputs the receiving-unit selection signal A 1014 and the station-selection operation signal A 1015 into the station selection controller 103 using the same steps as those manually executed by the user in the first embodiment.

Reference numeral 109 denotes a video recording unit for, when the station-selection video signal A 1012 is output from the station selection controller 103 after the programmed recording is started, recording the station-selection video signal A 1012 on a recording medium used for video, such as a hard disk and an optical disk. Reference numeral 1025 denotes a reproduced video signal that is obtained by reproducing recorded video recorded by the video recording unit 109. The reproduced video signal 1025 is output to the video output unit 104 so that the reproduced video signal 1025 is presented to a user.

Incidentally, the video signal which has been output to the video output unit is displayed in the display unit 105. However, this figure illustrates a configuration example in which a recorder and a display unit are built as one body. Therefore, it is obvious that even if the display unit is located outside the recorder, it is apparent that the points of the present invention are not changed.

Reference numeral 1026 denotes the priority information showing the priority order included in the programmed recording information 1024. Although not explicitly illustrated in the figure, the priority order is used in the same manner as that of the priority order, which is inputted into the selection priority controller 1034, and which is output from the priority-order storage unit 1036 for storing the priority order of each user. The priority order is used to judge the priority order. Incidentally, in this embodiment, because similar reference numerals are used to denote functions that are similar to those of the first embodiment, the description thereof will be omitted.

An embodiment of the present invention will be described with reference to FIGS. 12 and 13 as below.

As is the case with the first embodiment, as shown in FIG. 2, this embodiment also has a configuration in which there is a family including the television set 1, the monitor 2, and the recorder 3, which are connected to one another through the HUB 4 and the home networks A, B, C. Here, it is assumed that each of the user A 5 and the user B 6 is programming the recorder 3 as shown in FIG. 13.

First of all, on the assumption that the current time is 9:55 on November 9, programmed recording of No. 1 will be executed five minutes later. At this time, if the user B 6 is viewing a broadcast by use of the broadcast receiving unit A 101, immediately before the time becomes 10:00, the recording controller 108 extracts, from the programmed recording information 1024, information that specifies a broadcast receiving unit, and then inputs this information into the station selection controller 103 as the receiving-unit selection signal A 1014.

Just then, in the same steps as those described in the first embodiment, the station selection controller 103 detects that the programmed recording No. 1 conflicts with the user B 6 in the broadcast receiving unit A 101. Next, the selection priority controller 1034 compares the priority information 1026 extracted from the programmed recording information 1024 with the priority of the user B 6. If it is judged that the priority of this programmed recording is higher than that of the user B 6, as is the case with the first embodiment, the priority of the programmed recording No. 1 which uses the broadcast receiving unit A 101 is higher than that of the user B 6 according to the priority information 1039. Therefore, a message notifying that the use authority of the broadcast receiving unit A 101 will be transferred at 10:00. In this manner, the user B 6 is notified that viewing will be interrupted, and then the programmed recording is started at 10:00.

Incidentally, when the message is displayed, the message may also be explicitly presented beforehand for a length of the predetermined time prior to the recording start time so that the user can know how many minutes later the transfer will be carried out; for example, a message “the control of the broadcast receiving unit which you are using will be transferred to another user having the higher priority one minute later because of the programmed recording” is displayed. Moreover, the message may also be displayed a plurality of times step by step (for example, 10 second, 15 seconds, and 30 seconds before the transfer). Furthermore, it may also be so configured that after the use authority is transferred, in other words, after the programmed recording is started, a message “the control of the broadcast receiving unit which you are using has been transferred to another user having the higher priority of viewing because of the programmed recording” is displayed so as to notify the user who has released the authority that the use authority has been completely transferred.

Next, as shown in FIG. 13, in a state in which the programmed recording No. 2 which has been programmed by the user B 6 is being executed from 22:00, the recording time of No. 3 programmed by the user A 5, which overlaps with the programmed recording time of No. 2, comes. This case will be described as below.

In this case, as shown in FIG. 13, the same broadcast receiving unit B 102 is assigned to both of the programmed recording schedules. Therefore, a conflict between them will occur at 23:00. For this reason, the station selection controller 103 compares the priority of the programmed recording No. 2 with that of the programmed recording No. 3. As a result, it is judged that the priority of the programmed recording No. 3 is higher. Accordingly, as described above, the transfer of the use authority to use the broadcast receiving unit is carried out here. To be more specific, as soon as the recording No. 3 is started, the recording No. 2 is interrupted.

However, because the programmed recording is currently being executed, and because there is also a possibility that the user will not stay near by, the message for the above-described user having the lower priority is displayed at the end of the recorded video No. 2 as a video image so that the user in question is notified of the interruption of the recording. As a matter of course, besides them, if there is for example a recording history, the interruption may also be registered as the history. In another case, the message may also be displayed with the recorded video being appeared to be automatically edited; for example, the massage is displayed not at the end of the recorded video but at the beginning of the recorded video.

Moreover, in this example, the recording No. 2 is completely interrupted. However, for example, if it is possible to use another recorder capable of recording, the recording from 23:00 may also be relayed to the recorder in question. In this case, it may also be so configured that a message indicating a recorder to which the recording has been relayed, or to which the recording will be relayed, is recorded in the video when the recording by the recorder 3 is interrupted, and thereby the user B 6 is notified of the target recorder at the time of reproduction.

Incidentally, although it will not be described in detail, when programmed recording information is recorded, if the programmed recording information is marked with “*” as the priority order as shown in FIG. 13, this means that the corresponding programmed recording has no priority. Accordingly, if another programmed recording is executed at the specified time, irrespective of the priority order of the programmed recording, the use authority of the broadcast receiving unit is transferred until the execution of the programmed recording ends. When the execution of the programmed recording ends, the use authority is returned again, and then the recording is executed as much as possible. In this case, as a matter of course, the video is divided into pieces of interrupted parts. Therefore, some messages are recorded so that the interrupted parts can be identified when the video is reproduced.

In addition, although the description of the steps will be omitted, also for the recorder 3, if the station selection operation performed by the user B 6 having the lower priority causes the conflict with the programmed recording whose priority is higher than that of the user B 6 in a broadcast receiving unit, the programmed recording whose priority is higher is currently using the broadcast receiving unit. Therefore, it may also be so configured that the selection priority controller 1034 uses the priority information 1039 to present, to a user having the lower priority, a message notifying that it is not possible to acquire the use authority because the broadcast receiving unit A 101 in question is being currently used by the programmed recording. This message clears the reason why the use authority cannot be acquired.

### Third Embodiment

Next, a third embodiment of the present invention will be described as below.

In the first embodiment, the conflict resolution is based on the priority order that is defined beforehand by each user. However, in this embodiment, the priority order of each user or each device, which is stored in the priority-order storage unit 1036, is determined according to the order in which the use of a function (for example, a broadcast receiving unit), which is built into a device to be operated, is started. It is to be noted that operation performed after the determination of the priority order is the same as that of the first embodiment. Therefore, if the priority order is determined on a first-come-first-served basis, the conflict of using a broadcast receiving unit occurring between users, or between devices, is resolved by the same steps as those of the first embodiment. In addition, the timing in which the priority order is determined is judged at a point of time at which the use of a function to be shared (for example, a broadcast receiving unit) is started. FIG. 14 is a chart illustrating as an example of a change in the priority order in this embodiment. First of all, when the television set 1 starts the use of the broadcast receiving unit A 101 at the time t1 earlier, the first is assigned to the priority order of the television set 1. Next, when the monitor 2 starts the use of the broadcast receiving unit A 101 at the time t2 later, the second is assigned to the priority order of the monitor 2. Then, when the television set 1 stops the use of the broadcast receiving unit A 101 at the time t3, the priority order of the monitor 2 to which the second has been assigned at the time t2 is changed to the first. After that, at the time t4, the priority order of the television set 1 becomes the second. When the monitor 2 stops the use of the broadcast receiving unit A 101 at the time t5, the priority order of the television set 1 becomes the first again. Thus, the priority order changes with the progress of the operation, and the conflict is resolved according to the priority order at a point of time at which the conflict occurs.

As described above, in this embodiment, in a state in which the conflict occurs, the use authority is given to a user, or device whose priority order at that point or time is higher. Therefore, by properly presenting a message, or the like, to a user or device which could not acquire the use authority, the message notifying that the broadcast receiving unit cannot be used because the conflict occurs, it becomes possible to prevent a user from confusing even in a case where, for example, the user B 6 who is using a device over the network cannot directly know that the user A 5 has the higher priority.

When a device resource is shared among a plurality of users over a network, the same principles can be applied to a system in which one function can be used by only one user due to constraints on the device side.

What is claimed is:

1. An image display apparatus comprising:
at least one or more broadcast receiving units, each of which receives a broadcast and outputs a video signal;
an user interface unit which performs selection operation by which a first user specifies one of the broadcast receiving units for viewing, and station selection operation of specifying a broadcast channel to be received by the selected broadcast receiving unit;
a display unit which presents, to the first user, a video signal that is output by the broadcast receiving unit selected through the user interface;
a network interface unit which connects external device that is used by a second user to remotely perform each operation and viewing that are similar to each operation and viewing performed by the first user; and
a station selection control unit including:
a control unit which controls the selection of the broadcast receiving unit and the station selection on the basis of a priority order, which is assigned to each of the users beforehand, so as to resolve the conflict occurring when the first and second users share the broadcast receiving unit; and
a presentation unit which when the control is performed as a result of the occurrence of the conflict, presents to each of the users, through the display unit, a message notifying that the conflict will be resolved on the basis of the priority order.

2. The image display apparatus according to claim 1, wherein:
if a user having a higher priority tries to use a broadcast receiving unit that is currently being used by a user having a lower priority, the station selection control unit presents beforehand, to the user having the lower priority, a message notifying that the use authority to use the broadcast receiving unit in question will be transferred to the user having the higher priority from now, the message being presented before the use authority is transferred.

3. The image display apparatus according to claim 1, wherein:
if a user having a lower priority tries to use a broadcast receiving unit that is currently being used by a user having a higher priority, the station selection control unit presents, to the user having the lower priority, a message notifying that because the broadcast receiving unit in question is currently being used by the user having the higher priority, it is not possible to acquire the use authority.

4. The image display apparatus according to claim 1, wherein:
when the user having a lower priority also views at the same time the same broadcast channel as that being currently viewed by the user having a higher priority, if the user having the higher priority switches the channel to another broadcast channel, the station selection control unit presents, to the user having the lower priority who is viewing at the same time, a message notifying that the broadcast channel which is being viewed is switched to the other broadcast channel by the user having the higher priority, the message being presented concurrently with the switching.

5. The image display apparatus according to claim 1, wherein:
if the user having a lower priority performs remote control from an external device that is connected through the network interface unit, a message notifying that the use authority will be transferred is transmitted to the external device through the network interface unit.

6. An image recording apparatus comprising:
at least one or more broadcast receiving units, each of which receives a broadcast and outputs a video signal;
an user interface unit which performs selection operation by which a first user specifies one of the broadcast receiving units for viewing, and station selection operation of specifying a broadcast channel to be received by the selected broadcast receiving unit;
a programmed recording unit which records the video signal of the broadcast receiving unit, which is selected through the user interface, from the time that is specified by the first user beforehand;
a network interface unit which connects an external device that is used by a second user to remotely perform each operation and viewing that are similar to each operation and viewing performed by the first user;
an assignment unit which when each user programs the recording by use of the programmed recording unit, assigns the same priority order also to the programmed recording on the basis of the priority order assigned to each user beforehand so that if the conflict of sharing the broadcast receiving unit occurs between the first user who uses the broadcast receiving unit for the programmed recording that is programmed by use of the programmed recording unit, and the second user who is using the broadcast receiving unit for viewing, the conflict can be resolved; and
a station selection control unit including:
a control unit which controls the selection of the broadcast receiving unit and the station selection on the basis of the priority order assigned to each of the users and the priority order assigned to the programmed recording; and
a presentation unit which when the control is performed, presents to each of the users, a message notifying that the conflict will be resolved on the basis of each of the priority orders.

7. The image recording apparatus according to claim 6, wherein:
if the programmed recording unit with which recording has been programmed by a user having the higher priority tries to use a broadcast receiving unit which is currently being used for viewing by a user having the lower priority so that the programmed recording is started, the station selection control unit presents, to the user having the lower priority, a message notifying that the use authority to use the broadcast receiving unit in question will be transferred to the programmed recording unit with which the recording has been programmed by the user having the higher priority, the message being presented before the use authority is transferred.

8. The image recording apparatus according to claim 6, wherein:
if the programmed recording unit with which recording has been programmed by a user having the higher priority tries to use a broadcast receiving unit that is currently being used for recording by a user having the lower priority so that the programmed recording is started, when the use authority is transferred, the station selection control unit records a message as video and character data to recorded video, which has been programmed by the user having the lower priority, and which is currently being executed, the message notifying that the use authority to use the broadcast receiving unit in question will be transferred to the programmed recording unit with which the recording has been programmed by the user having the higher priority, the user having the lower priority being capable of explicitly checking the message at the time of reproducing the recorded video afterward.

9. The image recording apparatus according to claim 6, wherein:
if a user having the lower priority tries to use a broadcast receiving unit that is currently being used by the programmed recording unit with which recording has been programmed by a user having the higher priority, the station selection control unit presents, to the user having the lower priority, a message notifying that because the broadcast receiving unit in question is currently being used by the programmed recording unit with which the recording has been programmed by the user having the higher priority, it is not possible to acquire the use authority.

10. The image display apparatus according to claim 1, further comprising:
a presentation unit which, when the station selection control unit transfers the use authority to use the broadcast receiving unit, presents the messages to be transmitted to the user having the lower priority at least twice before and after the use authority is transferred, the message transmitted before the use authority is transferred being different from the massage transmitted after the use authority is transferred.

11. The image recording apparatus according to claim 6, further comprising:
a presentation unit which, when the station selection control unit transfers the use authority to use the broadcast receiving unit, presents the messages to be transmitted to the user having the lower priority at least twice before and after the use authority to use the broadcast receiving unit is switched to the programmed recording unit, the message transmitted before the use authority is switched being different from the massage transmitted after the use authority is switched.

12. A control system for image distribution, the control system comprising the steps of:
in an image display apparatus including at least one or more broadcast receiving functions, each of which receives an available broadcast and outputs a video signal by remote control through an user interface for device operation or a network, when the conflict of selecting the broadcast receiving function, or the conflict of selecting a program station, occurs between users, comparing priority orders that are given to each of users beforehand;
performing control so that a user whose priority is the highest can use the broadcast receiving function; and
if a transfer of the use authority occurs, concurrently with the transfer of the use authority, or immediately before the transfer of the use authority, or before and after the transfer of the use authority, presenting to at least a user whose use authority is low, a message notifying that the use authority has been transferred.

13. A control system for image distribution, the control system comprising the steps of:
in an image recording apparatus including at least one or more broadcast receiving functions, each of which receives an available broadcast and outputs a video signal by remote control through an user interface for device operation or a network, when the conflict of selecting the broadcast receiving function, or the conflict of selecting a program station, occurs between users, comparing priority orders that are given to each of the users beforehand;
performing control so that a user whose priority is the highest can use the broadcast receiving function; and
if a transfer of the use authority occurs, concurrently with the transfer of the use authority, or immediately before the transfer of the use authority, or before and after the transfer of the use authority, presenting to at least a user whose use authority is low, a message notifying that the use authority has been transferred.

14. An image display apparatus comprising:
at least one or more broadcast receiving units, each of which receives a broadcast and outputs a video signal;
an user interface unit which performs selection operation by which a first user specifies one of the broadcast receiving units for viewing, and station selection operation of specifying a broadcast channel to be received by the selected broadcast receiving unit;
a display unit which presents, to the first user, a video signal that is output by the broadcast receiving unit selected through the user interface; and
a network interface unit which connects an external device that is used by a second user to remotely perform each operation and viewing that are similar to each operation and viewing performed by the first user, wherein:
in order to resolve the conflict occurring when the first and second users share the broadcast receiving unit, the authority to select the broadcast receiving unit and to perform the station selection is given to a user who uses the broadcast receiving unit earlier, and a message indicating that the conflict has occurred, a message indicating that the selection of the broadcast receiving unit and the station selection cannot be performed, is presented to the user who has experienced the conflict.
